(19) United States
(12) Patent Application Publication
(10) Pub. No.: US 2020/0080605 A1
(43) Pub. Date: Mar. 12, 2020

(54) SUPPORT BRACKET

(71) Applicant: AKEBONO BRAKE INDUSTRY CO., LTD., Tokyo (JP)

(72) Inventors: Rory Daniel Hourihan, West Bloomfield, MI (US); Masaki Uchida, Novi, MI (US)

(21) Appl. No.: 16/126,133

(22) Filed: Sep. 10, 2018

(51) Int. Cl. F16D 65/00; F16D 55/22

(52) U.S. Cl. CPC F16D 65/0056; F16D 2055/0016; F16D 65/0068; F16D 55/22

(57) ABSTRACT

A bracket for connecting a brake caliper to a portion of a vehicle. The bracket includes a longitudinal section that extends between a first end and an opposing second end. The bracket includes a first extension that extends cantilevered from the first end of the bracket, and a second extension that extends cantilevered from the second end.

### FIELD

These teachings relate to a bracket that is configured to attach a brake caliper to a portion of a vehicle.

### BACKGROUND

Brake systems are configured to apply a braking force onto a braking surface to slow, stop, and/or prevent movement of a vehicle.

Suppliers of brake systems go to great lengths to minimize brake noise, vibration and harshness (Brake NVH), which may be perceived by customers as an indication of a problem with the brake system, which may adversely affect quality and satisfaction ratings, as well as warranty costs.

There is a continued need to improve current brake systems to reduce or eliminate Brake NVH.

### SUMMARY

These teachings provide a support bracket that is configured to attach or connect a brake caliper to a portion of the vehicle. The support bracket is also configured to distribute brake reaction forces between a first or leading end of the brake caliper, a second or leading end of the brake caliper, an inboard side of the brake caliper, the outboard side of the brake caliper, or a combination thereof. The support bracket is further configured to reduce or eliminate Brake NVH. The support bracket is configured to reduce or eliminate lingering low frequency noise issues.

These teachings provide a support bracket that comprises one or more extensions. The one or more extensions may function to reduce or eliminate Brake NVH. The one or more extensions may function to reduce or eliminate lingering low frequency noise issues. The one or more extensions may function to tune a frequency of the brake caliper to reduce instability at problem frequencies. The one or more extensions may function to separate frequencies within the vehicle or knuckle system by making the support bracket heavier and/or more rigid.

These teaching disclose a bracket comprising a mounting feature configured to connect the bracket to a brake caliper; a longitudinal section having a first end and an opposing second end, the longitudinal section extending within a plane. A terminal end of the first extension or a terminal end of the second extension is free from directly contacting the brake caliper.

These teaching disclose a brake system comprising a brake caliper comprising: an inboard wall, an opposing outboard wall; and a bracket for connecting the brake caliper to a portion of a vehicle. The bracket comprises: a longitudinal section; a first end comprising a mounting feature for attaching the first end of the bracket to the brake caliper; a second end comprising a mounting feature for attaching the second end of the bracket to the caliper; a first extension that extends cantilevered from the first end of the bracket, the first extension comprises: a first member that extends laterally outward from the first end of the longitudinal section in a direction away from the outboard side of the brake caliper; and a second member that extends from an end of the first member and in a direction towards a leading end of the brake caliper; a second extension that extends cantilevered from the second end of the bracket, the second extension comprises: a first member that extends laterally outward from the second end of the bracket in the direction away from the outboard side of the brake caliper; and a second member that extends from an end of the first member of the second extension and in a direction towards a trailing end of the brake caliper.

These teaching disclose a brake system comprising: a brake caliper comprising: an inboard wall, an opposing outboard wall; and a bracket for connecting the brake caliper to a portion of a vehicle. The bracket comprising: a longitudinal section; a first end comprising a mounting feature for attaching the first end of the bracket to the brake caliper; a second end comprising a mounting feature for attaching the second end of the bracket to the caliper; a first extension comprising a first notched portion configured to mate with a corresponding notched portion defined in the first end of the longitudinal section; and a second extension comprising a second notched portion configured to mate with a corresponding notched portion defined in the second end of the longitudinal section.

### BRIEF DESCRIPTION OF THE DRAWINGS

FIG. 1 is perspective view of a brake system comprising a brake caliper and a support bracket.

FIG. 2 is an exploded perspective view of the brake system of FIG. 1.

FIG. 3 is a bottom view of the brake system of FIG. 1

FIG. 4 is a side view of the brake system of FIG. 1

FIG. 5 is a perspective view of the support bracket.

FIG. 6 is a top view of the support bracket.

FIG. 7 is another perspective view of the support bracket.

FIG. 8 is a perspective view of another support bracket.

FIG. 9 is an exploded perspective view of the support bracket of FIG. 8.

FIG. 10 is another exploded perspective view of the support bracket of FIG. 8.

FIG. 11 is a close-up view of a portion of the exploded perspective view of the support bracket of FIG. 9.

FIG. 12 is a close-up view of another portion of the exploded perspective view of the support bracket of FIG. 9.

FIG. 13 is an exemplary graph illustrating instability vs. frequency of a support bracket without any extensions.

FIG. 14 is an exemplary graph illustrating instability vs. frequency of a support bracket that includes an extension located at each end of the support bracket.

FIG. 15A is a histogram illustrating % Occurrences of squeal frequencies.

FIG. 15B is a graph illustrating % Occurrences vs. Noise SPL.

FIG. 16A is a histogram illustrating % Occurrences of squeal frequencies.

FIG. 16B is a graph illustrating % Occurrences vs. Noise SPL.

FIG. 17A is a histogram illustrating % Occurrences of squeal frequencies.

FIG. 17B is a graph illustrating % Occurrences vs. Noise SPL.

### DETAILED DESCRIPTION

These teachings provide a brake system. The brake system may function to create clamping force to slow, stop, or prevent movement of a vehicle. For example, the brake system may be used to slow, stop, or prevent movement of one or more wheels of a vehicle, such as an automobile, a motorcycle, and/or an all-terrain vehicle (ATV). The brake system may also be used in non-vehicle related applications, such as amusement park rides, paper winders, and lathes to slow, stop, or prevent movement of a movable component.

The brake system may be a disc brake system or assembly. The brake system may be a fixed caliper system or assembly or a sliding caliper system or assembly. The brake system generally includes a brake caliper and a bracket.

The brake caliper may function to support one or more brake pistons. The brake caliper may function to support one or more brake pads. The brake caliper may be adapted to straddle a brake rotor such that an inboard brake pad supported on an inboard side of the brake caliper faces one side of the brake rotor, and an outboard brake pad supported on an outboard side of the brake caliper faces an opposing side of the brake rotor. The brake caliper may include a transverse wall or bridge that connects the inboard wall and the outboard wall. The transverse wall, the inboard wall, and the outboard wall may be made as a single structure or monoblock. Alternatively, two or more of the transverse walls, the inboard wall, and the outboard wall may be connected or attached together with a suitable fastener (e.g., by welding, mounting bolts, etc.).

The inboard side of the brake caliper may be adapted to support one or more brake pistons, and the outboard side of the brake caliper may be adapted to support one or more brake pistons. In another configuration, the inboard side of the brake caliper may be adapted to support one or more brake pistons, and the outboard side of the brake caliper may be free of any brake pistons, or vice versa. The number of brake pistons supported by the inboard and/or outboard sides may depend on the size of the brake caliper and the intended application for the brake system. For example, heavy duty or performance vehicles may have brake calipers that are configured to support a plurality of brake pistons, such as 2, 3, 4, 6, 8, or even 12 or more brake pistons. Light duty and passenger vehicles may only require 1 brake piston, for example.

The inboard side of the brake caliper may also function to connect the brake caliper and the bracket. However, in some configurations, the bracket may be connected to another portion of the brake caliper, like the outboard side, bridge, front or leading end of the brake caliper, back or training end of the brake caliper, or a combination thereof.

The inboard side of the brake caliper refers to a side of the brake caliper that is faces a center or center line of the vehicle, while the outboard side of the brake caliper refers to a side of the brake caliper that faces away from a center or center line of the vehicle. The leading end of the brake caliper refers to an end of the brake caliper that faces a forward direction of the vehicle when the vehicle is traveling in a forward direction. The trailing end of the brake caliper refers to an end of the brake caliper that faces a rearward direction of the vehicle when the vehicle is traveling in a forward direction.

The brake caliper may comprise one or more contact areas. A contact area may be a location, surface, or area defined on the brake caliper where the brake caliper contacts or engages the support bracket when the brake caliper and the support bracket are connected together. The contact area(s) may be on the inboard side of the brake caliper, outboard side, leading end, trailing end, a bottom side, a top side, or a combination thereof.

The support bracket may comprise one or more contact areas. A contact area may be a location, surface, or area defined on the support bracket where the support bracket contacts the brake caliper when the brake caliper and the support bracket are connected together.

The contact areas on the support bracket and corresponding contact areas of the brake caliper may generally oppose each other. The contact areas on the support bracket and corresponding contact areas of the brake caliper may be generally smooth or planar. Alternatively, contact areas on the support bracket and/or the corresponding contact areas of the brake caliper may include one or more surfaces or features for positively locking or engaging the support bracket and brake caliper.

A damper or damping material may be provided on the one or more contact areas of the brake caliper, the support bracket, or both. The damper or damping material may be compressed and/or sandwiched between the brake caliper and the support bracket after the brake caliper and support bracket are connected or attached together. The damper or damping material may, or may not, extend into the bores that are configured to receive a fastener for connecting together the support bracket and caliper.

The damper or damping material may function to reduce noise or vibrations by reducing or eliminating direct contact between the caliper, the support bracket, the fasteners, or a combination thereof.

The damper or damping material may be made from a vibration or noise reducing material like an elastomeric material, like plastic or rubber. The damper or damping material may be soft, resilient, deformable, and/or compliant material. The damper or damping material may include one or more metals, metalloids, nonmetals, or a combination thereof. One or more metals may include steel, titanium, aluminum, lead, or any combination thereof. One or more nonmetals may include one or more polymers, glass (e.g., silica), water, oil, carbon fiber, the like, or any combination thereof. One or more polymers may include one or more elastomeric materials. One or more elastomeric materials may include rubber, silicone, polyurethane, thermoplastics, or any combination thereof. One or more polymers may include one or more granules (e.g., sand, microspheres, etc.), one or more foamed materials, or both. The one or more damper materials may be compressible or incompressible.

Alternatively, the one or more contact areas of the brake caliper, support bracket or both may be free of any dampers or other materials so that the brake caliper and the support bracket directly contact each other after the brake caliper and support bracket are connected or attached together.

The brake system may comprise one or more brackets. The bracket may be referred to as a support bracket. The support bracket may function to connect or attach the brake caliper to a portion of a vehicle that remains immobile relative to the brake rotor, like a knuckle or the frame. The support bracket may function to distribute forces or brake reaction forces between a first or leading end of the brake caliper, a second or leading end of the brake caliper, an inboard side of the brake caliper, the outboard side of the brake caliper or a combination thereof. The support bracket may function to reduce or eliminate Brake NVH. The support bracket may function to reduce or eliminate lingering low frequency noise issues.

The support bracket may be removably attached or connected to the brake caliper with one or more fasteners, like bolts or screws. The support bracket may be permanently attached or connected to the brake caliper by welding, or by forming the support bracket and the brake caliper as a single, monolithic component. The support bracket may be removably attached or connected to an immobile portion of the vehicle with one or more fasteners, like bolts or screws. The bracket may be permanently attached or connected to an immobile portion of the vehicle by welding, or by forming the bracket and the immobile portion of the vehicle as a single monolithic component. The immovable portion of the vehicle may be a knuckle, for example. The support bracket may also be referred to herein as a bracket.

The support bracket may be made of a suitable material, such as, for example, steel, aluminum, cast iron, or other metals or non-metals.

The brake system, the support bracket, or both may comprise one or more extensions. The one or more extensions may function to add mass or weight to the support bracket or to one or more ends of the support bracket. By adding weight to the support bracket, frequencies or vibrations change thus reducing Brake NVH. The one or more extensions may function to reduce nose or Brake NVH by separating frequencies within the knuckle. The one or more extensions may function to tune a frequency of the brake caliper and/or caliper system to reduce instability at problem frequencies. The one or more extensions may function to, may be configured to, may be enabled to, etc. bend, flex, vibrate, or otherwise move to reduce brake NVH. The one or more extensions may function to, may be configured to, may be enabled to, etc. cause the support bracket to bend, flex, vibrate, or otherwise move to tune a frequency of a brake caliper or brake system to reduce brake NVH.

The one or more extensions may be material that is added onto the support bracket. Each of the extensions may add mass or weight to the support bracket or to the corresponding ends of the support bracket. For example, the weight of one of the extensions may be approximately the same as the weight of the entire support bracket, approximately ¾ of the weight of the support bracket, approximately ½ of the weight of the support bracket, approximately ⅓ of the weight of the support bracket, approximately ¼ of the weight of the support bracket, etc. For example, the weight of the support bracket may be on the order of about 500 grams, and the weight of one of the extensions may be on the order of about 300 grams. In some configurations, the combined weight of the extensions may be the same as or greater than the weight of the support bracket alone. For example, in some configurations, the weight of the support brackets may be approximately 450 grams, while the extensions may each weigh approximately ½ of the weight of the support bracket 300 grams. For example, the weight of the support bracket may have a weight of approximately 450 grams, while a total weight of the support bracket and extensions may be on the order of approximately 1100 grams or 1400 grams.

The extensions may be added to one or both of the ends of the support bracket. One or both of the extensions may cantilever from the corresponding ends of the support bracket. Cantilever means that one end of the extension is fixed or attached to the support bracket or to an end thereof, while an opposing end is not fixed to the support bracket, to the brake caliper, or both. Cantilever means that one end of the extension is fixed or attached to the support bracket or to an end thereof, while an opposing end is not fixed or is free from contacting the support bracket; is free from contacting or connecting to the brake caliper, or both. Cantilever may refer to that a terminal-most end of an extension extends beyond a terminal most end of the support bracket, the brake caliper, or both. Cantilever may refer to that a terminal-most end of the extension is free from contacting or connected to or with the support bracket, brake caliper, or both. Cantilever may refer to that a terminal-most end of the extension may be free to, configured to, or enabled to bend, flex, move, and/or vibrate to reduce brake NVH. Terminal end or terminal-most end may mean the distal-most end, or the extreme end of the extension.

The one or more extensions may be an extremity of the support bracket. An end or terminal end or distal most end of the extension may be free from contacting any portion of the support bracket, brake caliper, brake system, vehicle, etc.

The extensions may be removably attached to the support bracket. Removably attached means that one or more of the extensions can be attached to the support bracket, removed or separated from the support bracket, and then attached again to the support bracket any number of times without damaging the extensions, the support bracket, or both.

A removably attached extension may advantageously allow a user or a brake supplier or vehicle manufacturer or a repair shop to fine-tune the support bracket or the one or more extensions. That is, after the brake caliper is attached to a vehicle, a brake noise, vibration and harshness (Brake NVH) study may be performed where the noises, vibration and harshness is measured during forward and/or reverse braking. An extension having a suitable mass or weight or material can be customized and attached to the support bracket to reduce the brake NVH. Due to vehicle and/or brake system build or assembly tolerances, such a need for fine tuning the mass or weight or material of the extensions may be highly desirable, especially in high end or luxury-end vehicles. Moreover, as the brake pad friction material or linings wear, brake NVH may increase, and thus changing the weight or mass or material of the extensions may provide for the brake NVH to be controlled or reduced.

In some configurations, the extensions may be permanently attached to the support bracket. Permanently attached means that after one or more of the extensions are attached to the support bracket, the one or more extensions cannot be separated from the support bracket without damaging the one or more extensions, the support bracket, or both.

The one or more extensions may be attached to the support bracket with one or more fasteners, like screws, bolts, rivets, etc., which may permit permanent or removable attachment to the support bracket. The one or more extensions may be integrally formed with the support bracket so that the extensions and the support bracket are one piece and made of the same material. The one or more extensions may be integrally formed onto the support bracket in a secondary process, like over-molding or insert molding. In an over-molding or insert molding process, one or more of the extensions may be made of a different material than the support bracket. Both of the extensions may be made of the same material as the support bracket. Both of the extensions may be made of the same material, but different than a material of the support bracket. One of the extensions may be made of the same material as the support bracket, and another one of the extensions may be made of a different material. For example, the one or more extensions may be made of aluminum, metal, cast iron, rubber, or plastic.

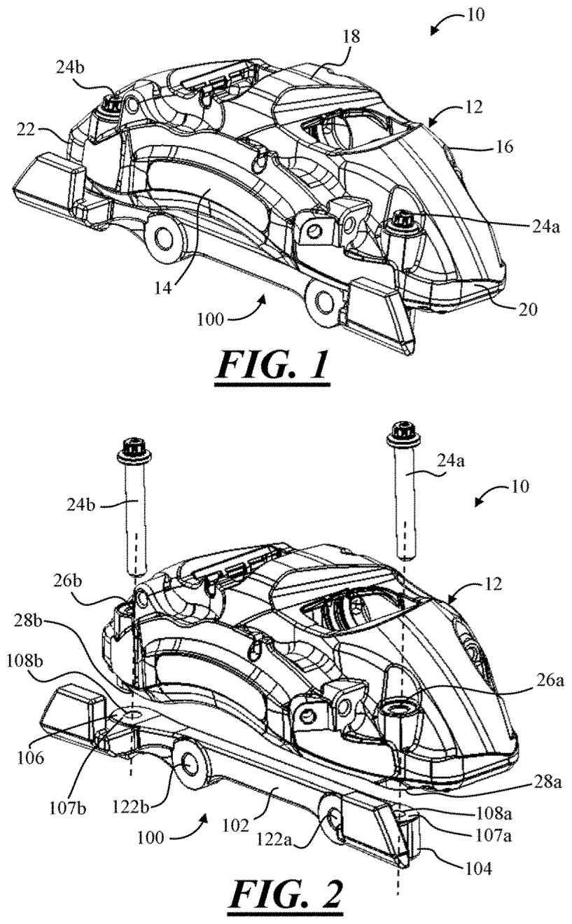

FIG. 1 illustrates a brake system 10. The brake system 10 comprises a brake caliper 12 and a support bracket 100.

The brake caliper 12 comprises a first or inboard side 14, an opposing second or outboard side 16, and a bridge 18 that extends between and connects the first and second sides 14, 16 of the brake caliper 12. The brake caliper 10 comprises a first or leading end 20, and an opposing second or trailing end 22.

The brake system 10 comprises one or more fasteners 24a, 24b that are configured to connect together the brake caliper 12 and the support bracket 100.

Referring to FIG. 2, the brake caliper 12 comprises bores 26a, 26b. The brake caliper 12 comprises one or more contact areas 28a, 28b that are configured to contact corresponding contact areas 107a, 107b on the support bracket 100 when the brake caliper 12 and the support bracket 100 are connected together.

The support bracket 100 comprises a longitudinal section 102 that extends between a first or leading end 104 and an opposing second or trailing end 106.

The support bracket 100 comprises one or more mounting features that are bores 108a, 108b. The one or more fasteners 24a, 24b are configured to extend through the corresponding bores 26a, 26b defined in the brake caliper 12 and the bores 108a, 108b defined in the support bracket 100 to connect together the brake caliper 12 and the support bracket 100.

The support bracket 100 comprises one or more mounting bores 122a, 122b that are configured to cooperate with other fasteners (not illustrated) to connect or attach the support bracket 100 and thus the brake system 10 to a portion of a vehicle, such as a knuckle.

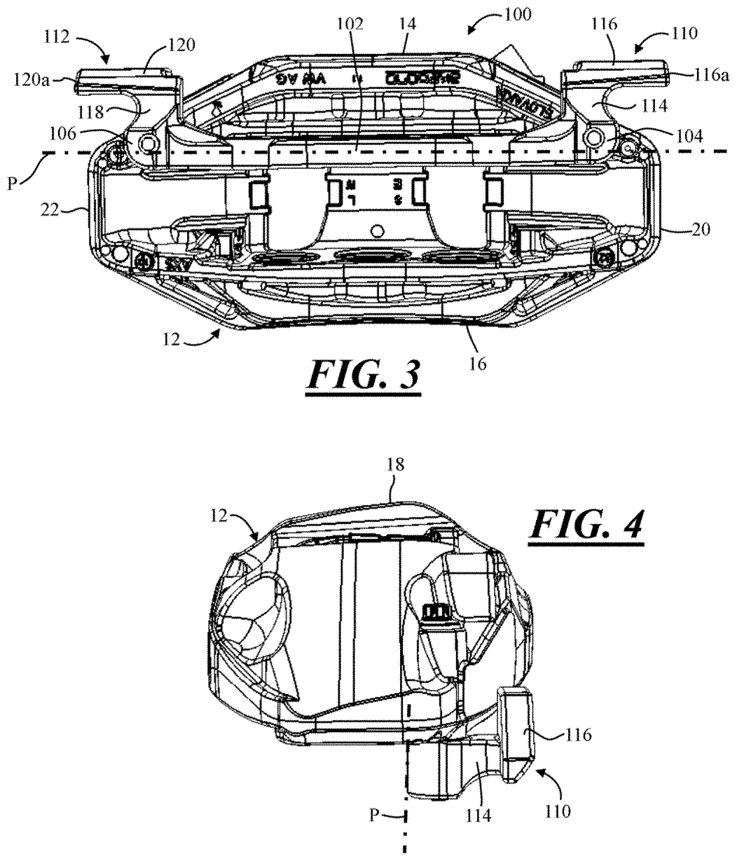

Referring to FIG. 3, the support bracket 100 comprises a first extension 110 located at the first or leading end 104 of the support bracket 100, and a second extension 112 located at the second or trailing end 106 of the bracket 100.

The longitudinal section 102 extends along or within a plane P. The plane P has a first side S1 that is located adjacent the brake caliper 12 or closest towards a longitudinal center line of the brake caliper 12 when the support bracket 100 is connected to the brake caliper 12. The plane P has a second side S2 that is located away from the brake caliper 12 or away from a longitudinal center line of the brake caliper 12 when the support bracket 100 is connected to the brake caliper 12.

The first extension 110 comprises a first member 114 that extends in a direction laterally outward from the first end 104 of the support bracket 100. The first member 114 extends from the support bracket 100, or from first end 104 of the support bracket 100, in a direction away from the first or inboard side 14 of the brake caliper 12, and in a direction away from a brake rotor that would be located between the first end second sides 14, 16 of the brake caliper 12. The first member 114 extends laterally outward from the first end 104 of the longitudinal section 102 in a direction that is angled relative to the plane P. The angled direction of the first member 114 may be any suitable angle relative to the plane P or the longitudinal section 102. For example, the angled direction of the first member 114 relative to the plane P or longitudinal section 102 may be approximately 15 degrees or more, approximately 30 degrees or more; approximately 45 degrees or more, approximately 60 degrees or more; approximately 75 degrees or more; approximately 90 degrees or more; approximately 105 degrees or more; approximately 120 degrees or more, approximately 135 degrees or more; approximately 150 degrees or more; approximately 165 degrees or more. The angled direction of the first member 114 may be generally perpendicular relative to the plane P or longitudinal section 102.

The first extension 110 comprises a second member 116 that extends from an end of the first member 114 and in a direction towards the first or leading end 20 of the brake caliper 12. The second member 116 extends from an end of the first member 114 in a direction that is angled relative to the plane P or longitudinal section. The angled direction of the second member 116 may be generally parallel relative to the plane P or longitudinal section 102. The angled direction of the second member 116 may be any suitable angle with the plane P or the longitudinal section 102. For example, the angled direction of the second member 116 relative to the plane P or longitudinal section 102 may be approximately 15 degrees or more, approximately 30 degrees or more; approximately 45 degrees or more, approximately 60 degrees or more; approximately 75 degrees or more; approximately 90 degrees or more; approximately 105 degrees or more; approximately 120 degrees or more, approximately 135 degrees or more; approximately 150 degrees or more; approximately 165 degrees or more.

A distal-most end or a terminal end 116a of the second member 116 may extend beyond the first or leading end 20 of the brake caliper 12; may be generally aligned with the first or leading end 20 of the brake caliper 12; or the first or leading end 20 of the brake caliper 12 may extend beyond the distal-most end 116a of the second member 116. The distal-most end or a terminal end 116a of the second member 116 is free from contacting any portion of the brake caliper 12.

The second extension 112 may be symmetrically opposite of the first extension 110. The second extension 112 comprises a first member 118 that extends in a direction laterally outward from the second end 106 of the support bracket 100. The first member 118 extends in a direction away from a brake rotor that would be located between the first end second sides 14, 16 of the brake caliper 12. The first member 118 extends laterally outward from the second end 106 of the longitudinal section 102 in a direction that is angled to the plane P. The angled direction of the first member 118 relative to the plane P or longitudinal section 102 may be any suitable angle. For example, the angled direction of the first member 118 relative to the plane P or longitudinal section 102 may be approximately 15 degrees or more, approximately 30 degrees or more; approximately 45 degrees or more, approximately 60 degrees or more; approximately 75 degrees or more; approximately 90 degrees or more; approximately 105 degrees or more; approximately 120 degrees or more, approximately 135 degrees or more; approximately 150 degrees or more; approximately 165 degrees or more. The angled direction may be generally perpendicular to the plane P or longitudinal section 102.

The second extension 112 comprises a second member 120 that extends from an end of the first member 118 and in a direction towards the second or trailing end 22 of the brake caliper 12. The second member 120 extends from an end of the first member 118 in a direction that is angled to the plane P or longitudinal section. The angled direction of the second member 120 may be generally parallel to the plane P or longitudinal section 102. The angled direction of the second member 120 may be any suitable angle with the plane P or the longitudinal section 102. For example, the angled direction of the second member 120 relative to the plane P or longitudinal section 102 may be approximately 15 degrees or more, approximately 30 degrees or more; approximately 45 degrees or more, approximately 60 degrees or more; approximately 75 degrees or more; approximately 90 degrees or more; approximately 105 degrees or more; approximately 120 degrees or more, approximately 135 degrees or more; approximately 150 degrees or more; approximately 165 degrees or more.

A distal-most end or a terminal end 120a of the second member 120 may extend beyond the second or trailing end 22 of the brake caliper 12; may be generally aligned with the second or trailing end 22 of the brake caliper 12; or the second or trailing end 22 of the brake caliper 12 may extend beyond the distal-most end 120a of the second member 120. The distal-most end or a terminal end 120a of the second member 120 is free from contacting any portion of the brake caliper 12.

Referring to FIG. 4, in addition to the second member 116 extending from the first member 114 of the first extension 110 in a direction towards the first or leading end 20 of the brake caliper 12 as illustrated in FIG. 3, the second member 116 also extends upwardly from the first member 114, in a direction towards the bridge 18 of the brake caliper 12.

While not illustrated in FIG. 4, the second extension 112 may be generally identical to the first extension 110. Therefore, the second member 120 of the second extension 112 also extends upwardly from the first member 118 of the second extension 112 in a direction of the bridge 18 of the brake caliper 12.

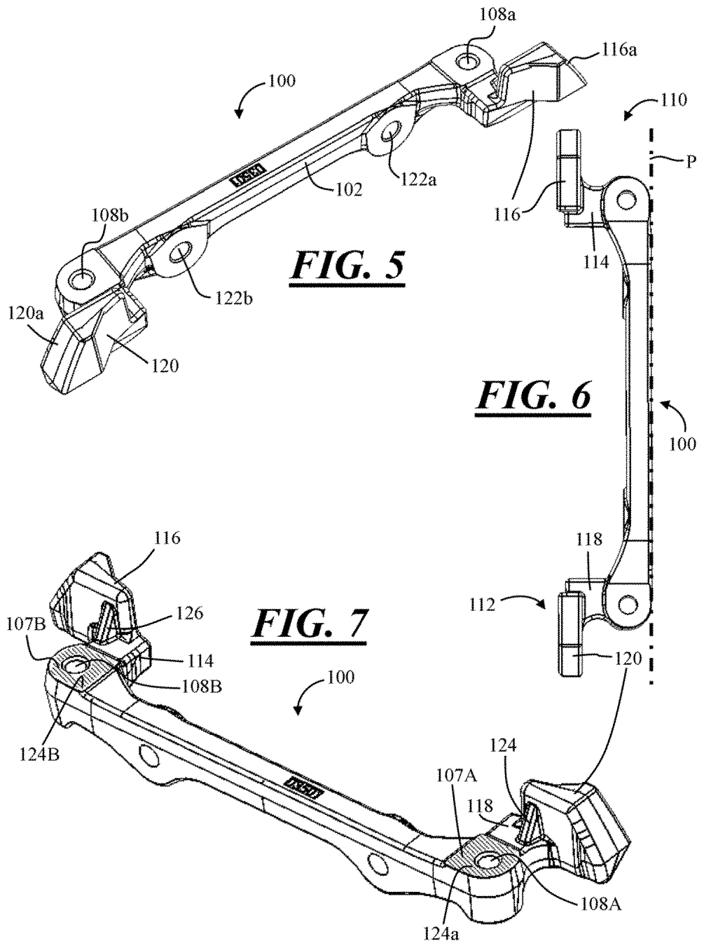

FIGS. 5, 6, and 7 each illustrate different orientations of the support bracket 100. A rib 124 may extend between and connect members 118 and 120 to provide strength and support thereto, and rib 126 may extend between and connect members 116 and 114 to provide strength and support thereto.

With specific reference to FIG. 7, the support bracket 100 may comprise a damper 124a at contact area 107A and/or a damper 124b at contact area 107B. The damper 124a and/or 124b may contact the corresponding contact areas 28a, 28b on brake caliper 12 when the brake caliper 12 and the support bracket 100 are connected together (See FIG. 2, for example). The damper 124a, 124b may, or may not, also extend into the corresponding bore 108A, 108B.

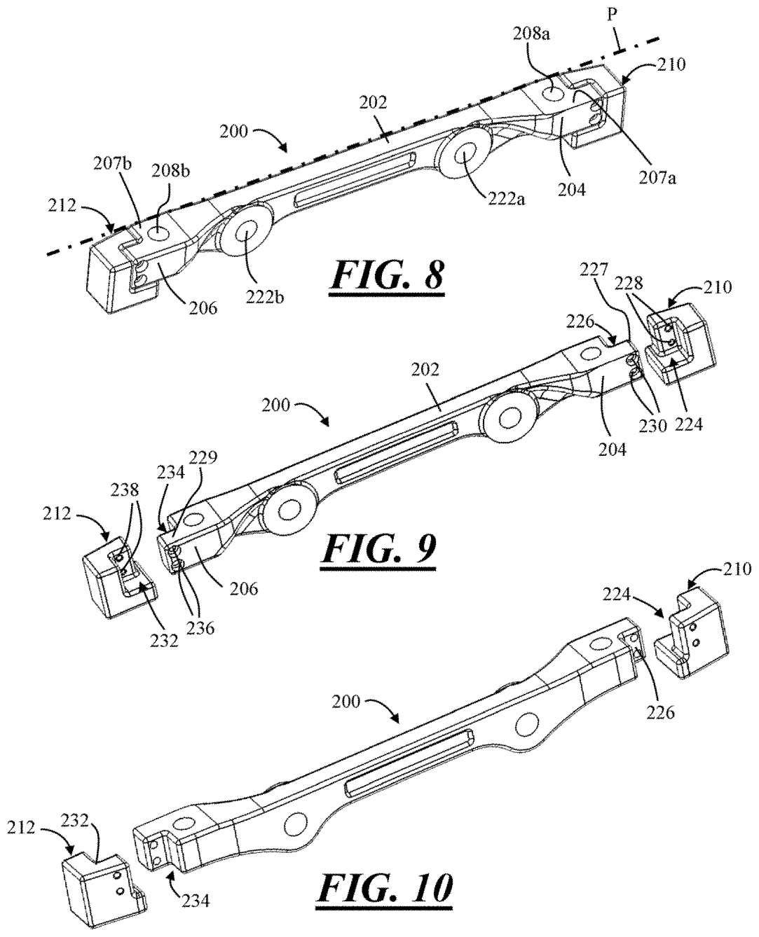

FIGS. 8, 9, and 9 illustrate another support bracket 200 that may be used in plate of support bracket 100 described and illustrated above.

The support bracket 200 comprises a longitudinal section 202 extending between a first or leading end 204 and an opposing second or trailing end 206. The longitudinal 202 extends along or within a plane P like the plane P illustrated and discussed above in the preceding paragraphs and figures.

Fasteners, like the fasteners 24a, 24b illustrated in FIGS. 1 and 2, are configured to extend through the corresponding mounting features or mounting bores 208a, 208b defined in the support bracket 200 and bores 26a, 26b defined in the brake caliper 12 (FIG. 2) to connect together the brake caliper 12 and the support bracket 200.

The support bracket 200 comprises contact areas 207a, 207b that are configured to contact corresponding contact areas 28a, 28b on the brake caliper 12 (FIG. 2) when the brake caliper 12 and the support bracket 200 are connected together. One or both of the contact areas 207a, 207b may include a damper like dampers 124a and/or 124b illustrated in FIG. 7, which may contact the corresponding contact areas 28a, 28b in brake caliper 12 when the brake caliper 12 and the support bracket 200 are connected together. The dampers may, or may not, extend into the corresponding bores 208A, 208B that are located at or near the corresponding ends 204, 206 of the support bracket 200.

The support bracket 200 comprises mounting bores 222a, 222b located in between the bores 208a, 208b. Mounting bores 222a, 222b are configured to cooperate with other fasteners (not illustrated) to connect or attach the support bracket 200 and thus a brake system to a portion of a vehicle.

The support bracket 200 comprises a first extension 210 at the first end 204, and a second extension 212 at the second end 206.

The first extension 210 extends from the first end 204 in a direction towards the first or leading end 20 of the brake caliper 12, and the second extension 212 extends from the second end 206 in a direction towards the second or trailing end 22 of the brake caliper 12 (FIGS. 1 and 2).

Referring to FIGS. 9 and 10, the first extension 210 comprises a notched portion 224 or pocket that is configured to mate with a corresponding notched portion 226 defined in the first end 204 of the support bracket 200 or receive the projection 227 extending from the end of the longitudinal section 202. The first extension 210 comprises bores 228, and the first end 204 comprises corresponding bores 230. Fasteners (not illustrated) are configured to extend through the corresponding bores 228, 230 to connect together the first extension 210 and the support bracket 200.

The second extension 212 comprises a notched portion 232 that is configured to mate with a corresponding notched portion 234 defined in the second end 206 of the support bracket 204 or receive the projection 229 extending from the end of the longitudinal section 202. The second extension 212 comprises bores 236, and the second end 206 comprises corresponding bores 238. Fasteners (not illustrated) are configured to extend through the corresponding bores 238, 236 to connect together the second extension 212 and the support bracket 200.

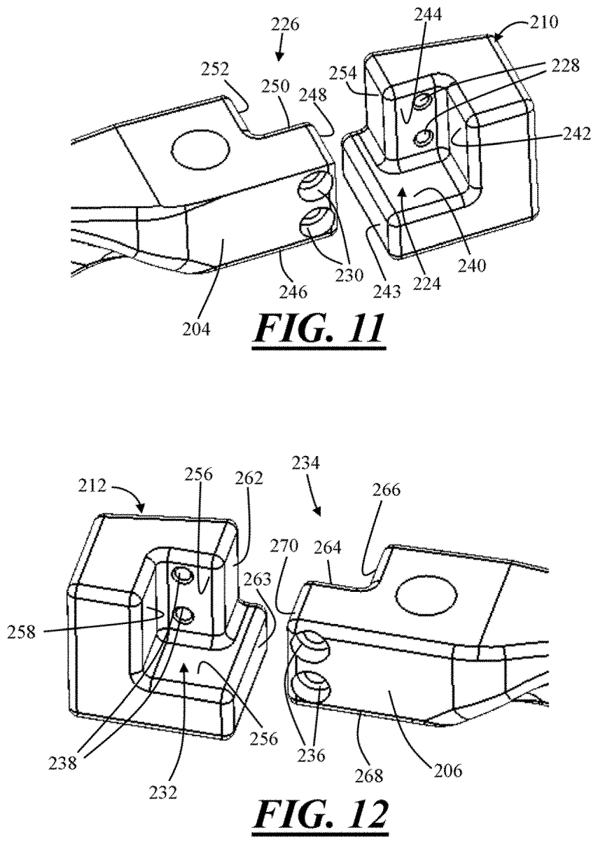

FIG. 11 illustrates the first extension 210 and the first end 204 of the support bracket 200.

The notched portion 224 of the first extension 210 is defined by a horizontal surface or wall 240, a first surface or wall 242, and a second surface or wall 244. The surfaces or walls 240, 242, 244 are generally orthogonal to one another, but they may have any angle relative to each other. The first extension 210 also comprises a third surface or wall 254 that is generally orthogonal to walls 240 and 244, and generally parallel to wall 242. The third surface or wall 254 is slightly recessed relative to a wall or surface 243.

The notched portion 226 of the first end 204 of the support bracket 200 comprises a first wall 250, a second wall 252, and a third wall or distal end 248. The walls 248, 250, 252 are all generally orthogonal to one another, but they can have any angle relative to each other.

When the first extension 210 is attached or connected to the support bracket 200, a bottom surface 246 of the first end 204 of the support bracket 200 is configured to contact or rest on the horizontal wall or surface 240 of the first extension 210; a distal-most end 248 of the first end 204 of the support bracket 200 is configured to contact or abut or be located immediately adjacent the first wall 242 of the first extension 210; the first wall 250 of the notched portion 226 is configured to contact or abut or be located immediately adjacent wall 244; and the second wall 252 of the notched portion 226 is configured to contact or abut or be located immediately adjacent wall 254 of the first extension 210. Fasteners (not illustrated) are configured to extend through the corresponding bores 228, 230 to connect and maintain the first extension 210 and support bracket 200 in a connected configuration. However, in some configurations, the components may be free of bores 228, 230 and instead the first and second extensions may be attached to the support bracket with other methods, such as, for example, welding, guiding, or even forming one or both of the extensions integrally with the support bracket.

Referring to FIG. 12, the notched portion 232 of the second extension 212 is defined by a horizontal wall or surface 256, a first wall or surface 258, and a second wall or surface 260. The walls 256, 258, 260 are generally orthogonal to one another, but they may have any angle relative to each other. The second extension 212 also comprises wall or surface 262 that is generally orthogonal to walls 256 and 256, and generally parallel to wall 258. The wall or surface 262 is slightly recessed relative to a wall or surface 263.

The notched portion 234 of the second end 206 of the support bracket 200 comprises a first wall 264 and a second wall 266. The walls 264, 266 are orthogonal to one another.

When the second extension 212 is attached or connected to the support bracket 200, a bottom surface 268 of the second end 206 of the support bracket 200 is configured to contact or rest on the horizontal wall 256 of the second extension 212; a distal-most end 270 of the second end 206 of the support bracket 200 is configured to contact or abut or be located immediately adjacent to the first wall 258 of the second extension 212; the first wall 264 of the notched portion 234 is configured to contact or abut or be located immediately adjacent to wall 256; and the second wall 266 of the notched portion 234 of the second end 206 of the support bracket 200 is configured to contact or abut or be located immediately adjacent to wall 262 of the first second extension 212. Fasteners (not illustrated) are configured to extend through the corresponding bores 238, 236 to connect and maintain the second extension 212 and support bracket 200 in a connected configuration.

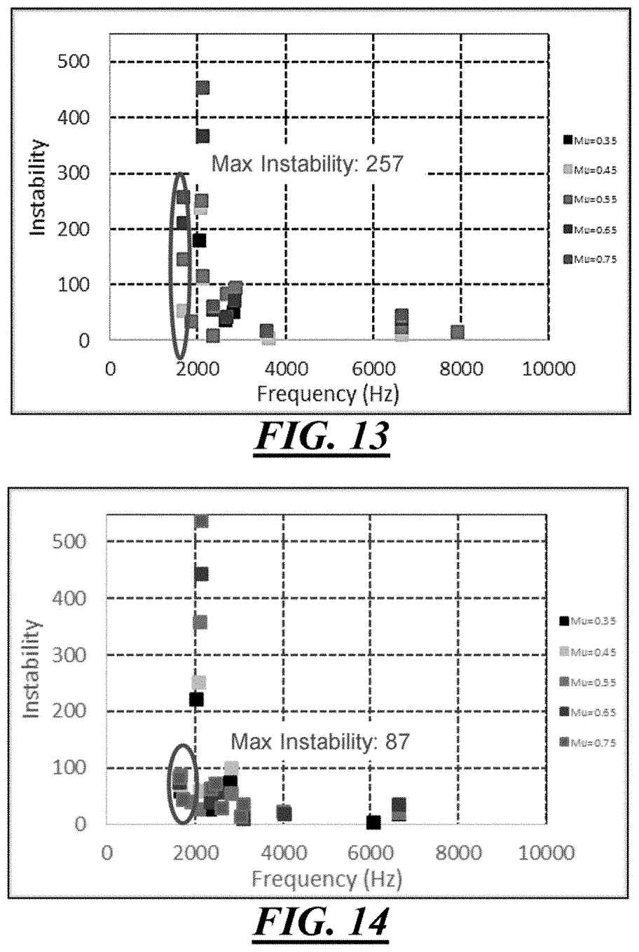

FIG. 13 illustrates a graph of instability vs. frequency of a support bracket without an extension located at the ends of the support bracket at five conditions at 1 MPa and Mu=0.35, 0.45, 0.55, 0.65, 0.75. At about 1.7 kHz, the instability is approximately 257.

FIG. 14 illustrates a graph of instability vs. frequency of a support bracket that includes one of the extensions disclosed herein located at each of the ends of the support bracket at five conditions at 1 MPa and Mu=0.35, 0.45, 0.55, 0.65, 0.75. At about 1.7 kHz, the instability is approximately 87, a drastic reduction compared to FIG. 13. As can be clearly seen, the addition of extensions to the ends of the support bracket at disclosed herein functions to reduce instability, noise, and thus Brake NVH.

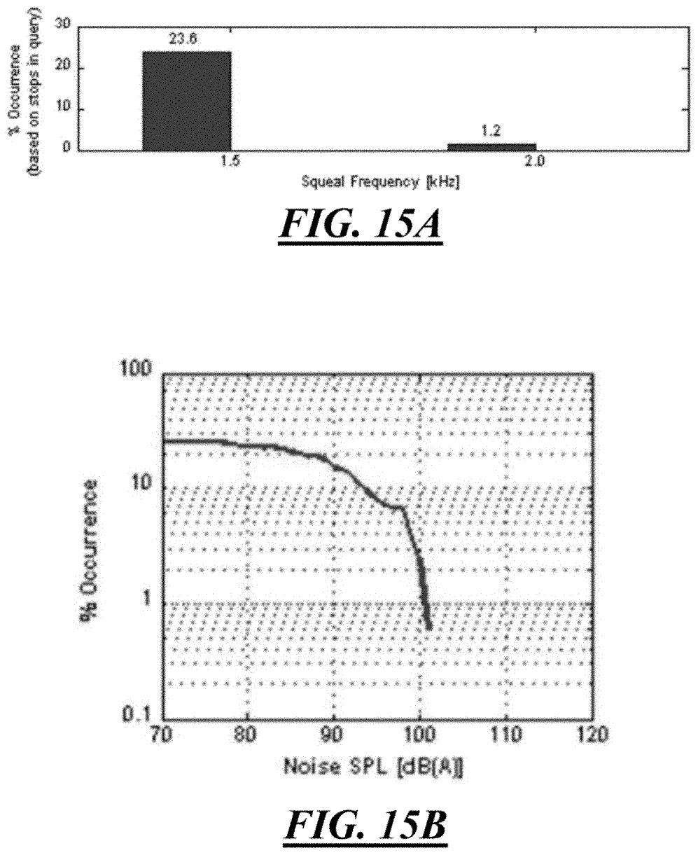

FIGS. 15A-17B illustrate test data for a brake system that includes a brake caliper and a support bracket. The same brake caliper was used in the tests illustrated in FIGS. 15A,B, 16A,B, and 17A,B. However, the support bracket was changed out in the tests illustrated in FIGS. 15A,B, 16A,B, and 17A,B.

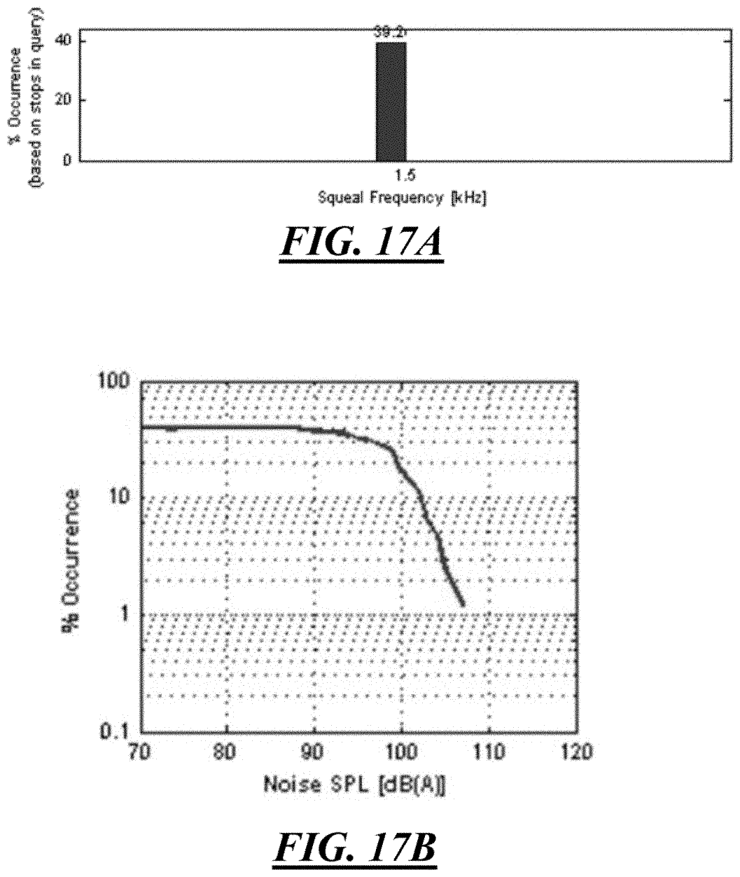

The brake system used to generate the data illustrated in FIGS. 15A,B included a support bracket without any extensions at the ends thereof. The support bracket used in FIGS. 15A,B was then exchanged with a support bracket that includes extensions to generate the data in 16A,B. The support bracket with the extensions used to generate the data in 16A,B was then exchanged with the same support bracket without the extensions from FIGS. 15A, B to generate the data in FIGS. 17A,B.

FIG. 15A is a histogram illustrating the % Occurrences of squeal frequencies of a brake system attached to a vehicle with a support bracket that does not include any extensions located at the ends thereof. The % Occurrences of squeal frequencies was approximately 23.6 at 1.49 kHz for a total number of stops of 190 in a forward and reverse direction.

FIG. 15B illustrates % Occurrences vs. Noise SPL (sound pressure level or acoustic pressure level) for the brake system of FIG. 15A. The maximum SPL was approximately 101 dB(A).

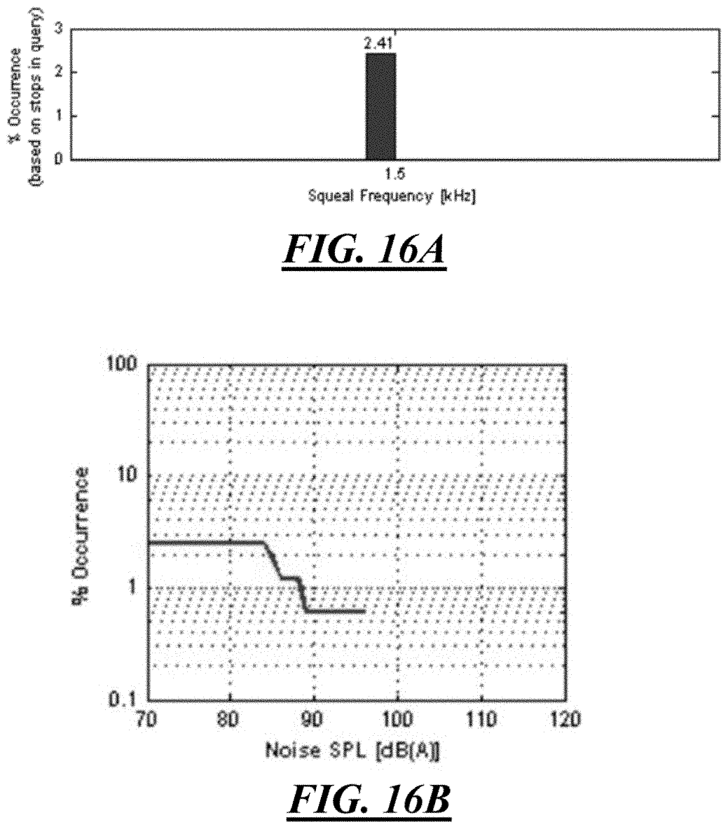

FIG. 16A is a histogram illustrating the % Occurrences of squeal frequencies of a brake system attached to a vehicle with a support bracket that includes extensions located at the ends thereof. The extensions are those illustrated at FIGS. 1-7; however, a support bracket having the extensions illustrated in FIGS. 8-12 had similar results. The % Occurrences of squeal frequencies was approximately 2.1 at 1.49 kHz for a total number of stops of 192 in a forward and reverse direction, which is a drastic reduction in the % occurrences of squeal frequencies compared to the brake system tested in FIG. 15A, which was a brake system with a support bracket that did not include any extensions as the ends thereof.

FIG. 16B illustrates % Occurrences vs. Noise SPL (sound pressure level or acoustic pressure level for the brake system of FIG. 16A. The maximum SPL was approximately 96.3 dB(A).

FIG. 17A is a histogram illustrating the % Occurrences of squeal frequencies of a brake system attached to a vehicle with a support bracket that does not include any extensions located at the ends thereof. The support bracket used in FIGS. 17A and 17B was the same support bracket used to generate the data in FIGS. 15A and 15B (i.e., a brake system comprising a support bracket without any extensions at the end thereof). The data in FIGS. 17A, 17B confirms that the reduction in % occurrences was attributed a brake system that includes a support bracket with extensions. The % Occurrences of squeal frequencies was approximately 33.9 at 1.49 kHz for a total number of stops of 192 in a forward and reverse direction.

FIG. 17B illustrates % Occurrences vs. Noise SPL (sound pressure level or acoustic pressure level) for the brake system of FIG. 17A. The maximum SPL was approximately 107.7 dB(A).

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The disclosures of all articles and references, including patent applications and publications, are incorporated by reference for all purposes. Other combinations are also possible as will be gleaned from the following claims, which are also hereby incorporated by reference into this written description.

1) A bracket comprising:
a) a mounting feature configured to connect the bracket to a brake caliper;
b) a longitudinal section extending between a first end and an opposing second end, the longitudinal section extending within a plane;
c) a first extension that extends cantilevered from the first end; and
d) a second extension that extends cantilevered from the second end;
wherein a terminal end of the first extension or a terminal end of the second extension is free from directly contacting the brake caliper.

2) The bracket according to claim 1, wherein the first extension comprises a first member that extends laterally outward from the first end of the longitudinal section in a direction that is angled relative to the plane.

3) The bracket according to claim 2, wherein the direction is generally perpendicular to the plane.

4) The bracket according to claim 2, wherein the first extension comprises a second member that extends from an end of the first member in a second direction that is angled relative to the plane.

5) The bracket according to claim 4, wherein the second direction is generally parallel relative to the plane.

6) The bracket according to claim 4, wherein the terminal end of the first extension is located at a terminal end of the second member.

7) The bracket according to claim 5, wherein the second extension comprises
a) a first member that extends laterally outward from the second end of the longitudinal section in a third direction that is angled relative to the plane, and
b) a second member that extends from an end of the second member in a fourth direction that is angled relative to the plane.

8) The bracket according to claim 7, wherein the third direction is generally perpendicular relative to the plane, and the fourth direction is generally parallel relative to the plane.

9) The bracket according to claim 1, wherein each of the first end and the second end comprise a contact area that is configured to contact a corresponding contact area of the brake caliper after the brake caliper and the bracket are connected together, and
wherein one or both of the contact areas of the bracket comprises a damper.

10) The bracket according to claim 1, wherein the first extension comprises a notched portion that is configured to mate with a corresponding notched portion defined in the first end of the longitudinal section.

11) The bracket according to claim 10, wherein the notched portion of the first extension is defined by a plurality of adjacent walls that are angled relative to one another.

12) The bracket according to claim 9, wherein the plurality of adjacent walls defining the notched portion of the first extension are substantially orthogonal one another.

13) The bracket according to claim 1, wherein the first extension comprises a pocket that is configured to receive a projecting member that extends from the first end of the longitudinal section.

14) The bracket according to claim 13, wherein the first end comprises mounting features that are configured to cooperate with mounting features defined in the projecting member to connect together the first end and the first extension.

15) The bracket according to claim 14, wherein the mounting features of the first end are bores, which are arranged generally perpendicular to the plane.

16) The bracket according to claim 13, wherein one or both of the first extension and the second extension are configured to be removably attached to the corresponding ends of the bracket without destroying the corresponding ends of the bracket and without destroying the corresponding extensions.

17) The bracket according to claim 1, wherein one or both of the first extension and the second extension are configured to be removably attached to the corresponding ends of the bracket without destroying the corresponding ends of the bracket and without destroying the corresponding extensions.

18) A brake system comprising:
a) a brake caliper comprising: an inboard wall and an opposing outboard wall; and
b) a bracket that is configured to connect the brake caliper to a portion of a vehicle, the bracket comprising:
i) a longitudinal section;
ii) a first end comprising a mounting feature for attaching the first end of the bracket to the brake caliper;
iii) a second end comprising a mounting feature for attaching the second end of the bracket to the caliper;
iv) a first extension that extends cantilevered from the first end of the bracket, the first extension comprises:
a. a first member that extends laterally outward from the first end of the longitudinal section in a direction away from the outboard side of the brake caliper; and
b. a second member that extends from an end of the first member and in a direction towards a leading end of the brake caliper;
v) a second extension that extends cantilevered from the second end of the bracket, the second extension comprises:
a. a first member that extends laterally outward from the second end of the bracket in the direction away from the outboard side of the brake caliper; and
b. a second member that extends from an end of the first member of the second extension and in a direction towards a trailing end of the brake caliper.

19) A brake system comprising:
a) a brake caliper comprising: an inboard wall, an opposing outboard wall; and
b) a bracket that connects the brake caliper to a portion of a vehicle, the bracket comprising:
i) a longitudinal section;
ii) a first end comprising a mounting feature for attaching the first end of the bracket to the brake caliper;
iii) a second end comprising a mounting feature for attaching the second end of the bracket to the caliper;
iv) a first extension comprising a first notched portion configured to mate with a corresponding notched portion defined in the first end of the longitudinal section; and
v) a second extension comprising a second notched portion configured to mate with a corresponding notched portion defined in the second end of the longitudinal section.

20) The brake system according to claim 19, wherein one or both of the first extension and the second extension are configured to be removably attached to the corresponding ends of the bracket without destroying the corresponding ends of the bracket and without destroying the corresponding extensions.
